(19) United States
(12) Patent Application Publication
(10) Pub. No.: US 2012/0104175 A1
(43) Pub. Date: May 3, 2012

(54) Space-based anti-missile defensive system (SAMS)

(76) Inventor: Harold James Willard, JR., Washington, DC (US)

(21) Appl. No.: 12/929,417

(22) Filed: Jan. 24, 2011

Related U.S. Application Data
(60) Provisional application No. 61/282,460, filed on Feb. 16, 2010.

(51) Int. Cl. F41H 11/02; F42B 7/04; F42B 12/64; B64G 1/00

(52) U.S. Cl. 244/158.1; 102/501

(57) ABSTRACT

This invention presents a missile defensive system based on existing technology in which numerous non-explosive, meteor-like projectiles are launched in a shotgun manner from an orbiting space station at an enemy's missiles while on earth or in flight. Collateral damage is minimized with this system. This Spaced-based Anti-Missile System (SAMS) requires international cooperation. An International Orbital Treaty Organization (IOTO) is proposed.

Reference to prior application: Provisional Patent Application filed Feb. 16, 2010; Application No. 61/282,460; Confirmation No. 4012.

### REFERENCES CITED

1. Caldicott, Helen, The New Nuclear Danger, George W. Bush's Military Industrial Complex, The New Press, New York, 2004, pp. 9-11.
2. Willard, H. James, Jr., “Roots of Peace” unpublished essay submitted to The Christian Science Monitor, 1986, as an entry to contest, “How peace was achieved in the year 2001”.
3. Broad, William J., Teller's War, The Top-Secret Story Behind the Star Wars Deception, Simon & Schuster, N.Y., 1992.
4. Simpson, Theodore R., The Space Station, An Idea Whose Time Has Come, IEEE Press, New York, 1984, p. 125.
5. Reed, Thomas C. and Stillman, Danny B., The Nuclear Express, A Political History of the Bomb and Its Proliferation, Zenith Press, Minneapolis, Minn., 2009, pp. 134, 140.

### U.S. PATENT DOCUMENTS

1. Willard H. James, Jr., Provisional Patent Application, “Rotating space station torque eliminator”; filed Feb. 3, 2010; Appl. No. 61/282,404; Conf. no. 2847.

### BACKGROUND OF THE INVENTION

A rogue nation with the capability of launching a nuclear missile poses an extremely serious threat to humanity. Such an event could precipitate a global exchange of nuclear weapons resulting in millions of deaths and inestimable destruction. Furthermore, if even one such missile should strike a nuclear power plant or the spent fuel storage facility adjacent to the plant, the damage could be magnified by factors of thousands due to the spread of radioactivity (Ref. 1)

If the planes which struck the Twin Towers in the 9/11 attack had instead struck the Indian Point nuclear power plant located just north of New York City, it is probable that today parts of the City would be uninhabitable and would remain so for centuries, with the immediate and long term loss of life in the thousands. Long term genetic effects would have been inestimable.

Given the rapid spread of technology, the threat of such devastation may not be limited to nations. Even a relatively small group of individuals, with sufficient resources, might undertake such a venture with the intent of extorting wealth or power from a city or a state, or even the United Nations.

Rational leaders of nations must have a variety of methods for dealing with such threats. However, it could be unwise and counter-productive to respond to such a threat with an equal use of force: to use nuclear weapons to knock out nuclear missiles.

A stabilizing counter-measure is desirable which can be used without the fear of making the situation worse.

The inventor proposed such a system in 1986 in an unpublished essay, “Roots of Peace”, which was submitted to The Christian Science Monitor as part of a contest on the theme “How peace was achieved in the year 2001”. As one of several recommendations, he described an orbiting space station manned by an international crew which would fire small missiles with non-explosive warheads at a large missile during launch or shortly thereafter. At the very high velocities attained by such meteor-like projectiles, they could easily penetrate the skin of a missile, destroying it. Many such projectiles could fit into the nose cone of a small rocket to be released in the vicinity of the targeted missile, similar to the action of a shotgun shell. Such rock-like particles would appear to be meteors, brightly lit due to heat generated by friction as they sped through the atmosphere, depending upon the altitude at which they were released (Ref. 2).

During the 1980s, over $25 billion was spent by the USA on a “Star Wars” approach to anti-missile defense under the direction of Edward Teller (Refs. 1, 3). Teller's concept was to explode a nuclear bomb in space and focus the emitted x-rays via mirrors onto an enemy's missiles in flight at high altitudes. In late 1986, President Reagan abandoned this approach and Teller began working on his “Brilliant pebbles” approach (Ref. 3), which used small guided missiles in space, without explosive warheads, to strike enemy missiles in flight. It is not known, as best the present inventor can determine, whether such a system was fully deployed or abandoned. However, it is often reported in the press that guided missiles fired from earth are used to intercept aircraft and missiles in combat situations, as direct contact devices.

The present invention uses a space station, perhaps permanently manned by an international crew, from which small shotgun shell-like missiles with non-explosive pellets can be fired against a missile or other target in the early stage of launch. If even one of the small, high density pellets were to hit the target, the missile could be destroyed. However, if they missed, the only damage done would be that equivalent to that of small rocks falling from space. Collateral damage would be minimized.

The inventor considers that the space station, to be fully effective, should follow the concept proposed by Von Braun in the 1950s (Ref. 4) in which astronauts lived and worked inside a rotating ring which provided an artificial gravitational environment, essential for their health for long term missions. This station was never constructed.

Such a station requires a means to counteract the torque required to initiate and control its rotation. The inventor has proposed such a means in his Provisional Patent Application, “Rotating space station torque eliminator”, filed on Feb. 3, 2010.

The likelihood that a small projectile could cause a nuclear weapon to detonate prematurely at launch is remote for missiles built by the United States, which goes to great lengths and expense to ensure that such an event cannot happen (Ref. 3). However, a rogue state or group may not, probably would not, have the technology to take such precautions, or the will. The possibility that a nuclear missile which they had constructed could explode on their territory might be an inducement not to build such devices.

The use of this system encourages international cooperation, such as achieved with NATO, the North Atlantic Treaty Organization. An International Orbital Treaty Organization (IOTO) could fulfill a similar function for space, but also include commercial, humanitarian, military, and scientific functions.

### BRIEF SUMMARY OF THE INVENTION

This invention presents a missile defensive system based on existing technology used in a novel way in which numerous, non-explosive, meteor-like projectiles are launched in a shotgun manner from an orbiting space station against an enemy's missiles while on earth or in flight. This system avoids the use of nuclear weapons in space. It also provides a humane defense against nuclear weapons on earth since non-explosive pellets are used in a manner such as to minimize collateral damage. Because this system uses well-proven technology for the projectiles, its reliability should be greater than that expected for systems requiring new missile developments.

This system encourages international cooperation, such as now exists with NATO. An International Orbital Treaty Organization (IOTO) is proposed to perform a similar function in space.

This system adds impetus to the development of a more substantial orbiting space nation than now currently exists, for humanitarian, commercial, and scientific purposes, as well as to perform military functions.

### DETAILS OF THE INVENTION

The engineering of ballistic missile design and operation is complex, but well established. The purpose of the elementary discussion presented here is to demonstrate that the proposed system is consistent with basic principles for a reasonable choice of variables. An actual system's parameters would depend upon the specific conditions identified for its application.

FIG. 1 is a schematic of the proposed system. An orbiting rotating wheel space station (1) is in near-earth orbit of 270 nautical miles (nm), permanently manned with an international crew. When it passes within range of a targeted missile (4), the crew launches a small missile (2), perhaps one of many, having a nose cone containing high density pellets (3). Such pellets could be tungsten, tantalum, or steel. Uranium is less preferable than other metals because of its association with radioactivity, although of high density.

At a pre-determined altitude if the targeted missile is still on the launching pad, or a pre-determined distance from the missile if the missile is in flight, the small missile releases pellets directed towards the target.

Even in the absence of a significant initial velocity, the final velocity of the pellets due to gravity can be high. Ignoring frictional effects for this estimate,

$${v}_{e} = \sqrt{{v}_{s}^{2} + 2 \cdot G \cdot {M}_{e} ( \frac{1}{{R}_{e}} - \frac{1}{{\underline{\underline{R}}}_{s}} )} . \qquad Eqn . 1$$

where
Vₛ is the velocity of the missile at launch (=0);
G is the universal-gravitational constant (6.67E-11 NM²/kg²);
Mₑ is the mass of the Earth (598E24 kg);
   Rₑ is the radius of the Earth (6.38E6 M);
   Rₛ is the distance from the center of the Earth to the space station (6.88E6 M);
   Vₑ is the velocity of a pellet as it reaches Earth M/s);

Using the above in Equation 1 yields 3015 M/s (6,742 MPH). The actual velocity would be somewhat less due to friction, but should be quite sufficient to penetrate the skin of a missile. If the pellets are expelled in a shotgun-like manner, their velocities would be increased.

The minimum flight time would be, approximately,

$$Δ T = \frac{1}{\sqrt{2 \cdot {M}_{e} \cdot G}} \cdot \frac{\underline{2}}{3} \cdot ( {R}_{s}^{1.5} - {R}_{e}^{1.5} ) = 46 s \qquad Eqn . 2$$

The orbiting station at an altitude of 270 nm (5.0E5 M) has an angular velocity of

$$w = \sqrt{\frac{{M}_{e} \cdot G}{{R}_{s}^{3}}} = 1.11 E - 3 \text{/} s ( 15.2 rev \text{/} day ) \qquad Eqn . 3$$

The velocity of the station is

$${V}_{s} = R \cdot w = 6616 m \text{/} s ( 17 , 04 MPH ) \qquad Eqn . 4$$

For a 15^{\hat{∘}} window over the target, the station spends a time,

$$Δ T = \frac{π / 12}{w} = 236 s \qquad Eqn . 5$$

This presumably is sufficient time to identify and lock onto the target.

The flight of the pellets should be that of small meteors impacting the target area: little or no damage to the area if they miss, but those who hit the targeted missile may destroy it.

If an impact should cause a targeted missile to explode, the damage will have been done essentially by the enemy to himself. This should encourage him not to pursue such adventures.

The targets for this system are not limited to missiles. This system could be used against stationary targets, including troops, in both defensive and offensive maneuvers.

### DESCRIPTION OF THE FIGURE

FIG. 1. Schematic of space-based anti-ballistic missile system.

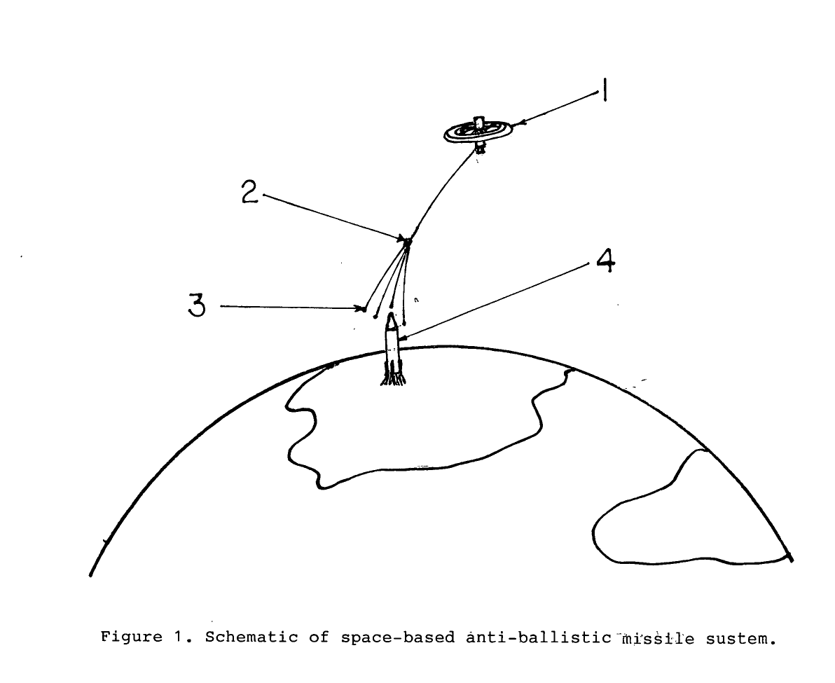

1. A Space-Based Anti-Ballistic Missile System (SAMS) is conceived using existing technology in a novel way which does not employ nuclear weapons in space or on earth.

2. A humane defensive system against nuclear-missiles is conceived using non-explosive shotgun-like projectiles in a manner such that collateral damage is minimized.

3. A space-based defensive system against nuclear missiles is conceived which encourages cooperation among nations. An International Orbital Treaty Organization (IOTO) is conceived to fulfill this function.
